(19) United States
(12) Patent Application Publication
(10) Pub. No.: US 2023/0297856 A1
(43) Pub. Date: Sep. 21, 2023

(54) Inference Processing Apparatus

(71) Applicant: Nippon Telegraph and Telephone Corporation, Tokyo (JP)

(72) Inventors: Yuki Arikawa, Tokyo (JP); Takeshi Sakamoto, Tokyo (JP)

(21) Appl. No.: 18/006,533

(22) PCT Filed: Aug. 5, 2020
(86) PCT No.: PCT/JP2020/030021

§ 371 Date: Jan. 23, 2023

(51) Int. Cl. G06N 5/04; G06N 3/04

(52) U.S. Cl. CPC G06N 5/04; G06N 3/04

(57) ABSTRACT

An inference processing device uses a learned neural network to infer a feature of input data, the inference processing device including: a first storage unit that stores the input data; a second storage unit that stores a weight of the learned neural network; a data filtering unit that extracts only specific input data from pieces of the input data; and an inference operation unit that uses the specific input data extracted by the data filtering unit and the weight as inputs, performs inference operation of the learned neural network, and infers the feature of the input data.

### CROSS-REFERENCE TO RELATED APPLICATIONS

This application is a national phase entry of PCT Application No. PCT/JP2020/030021, filed on Aug. 5, 2020, which application is hereby incorporated herein by reference.

### TECHNICAL FIELD

The present invention relates to an inference processing device, and particularly relates to a technology of performing inference using a neural network.

### BACKGROUND

In recent years, with an increase in the number of edge devices such as mobile terminals and Internet of Things (IoT) devices, the amount of generated data has explosively increased. For extracting meaningful information from the enormous pieces of data, a state-of-the-art machine learning technology called a deep neural network (DNN) is superior. With the recent progress of studies on the DNN, the accuracy of data analysis has been greatly improved, and further development of technologies using the DNN is expected.

The processing of the DNN has two phases of learning and inference. In general, learning requires a large amount of data, and thus may be processed in the cloud. On the other hand, in the inference, a learned DNN model is used to estimate an output for unknown input data.

More specifically, in the inference processing in the DNN, input data such as time-series data or image data is given to a learned neural network model and a feature of the input data is inferred. For example, according to a specific example disclosed in Non Patent Literature 1, a sensor terminal equipped with an acceleration sensor and a gyro sensor is used to detect an event such as rotation or stop of a garbage collection vehicle, thereby estimating the amount of garbage. As described above, in order to estimate an event at each time using unknown time-series data as an input, a neural network model obtained by performing learning in advance using time-series data in which an event at each time is known is used.

In Non Patent Literature 1, time-series data acquired from a sensor terminal is used as input data, and it is necessary to extract an event in real time. Therefore, it is necessary to further increase the speed of inference processing. In a conventional method, an FPGA that implements processing is mounted on a sensor terminal, and inference operation is performed by such an FPGA to increase processing speed (see, for example, Non Patent Literature 2).

### CITATION LIST

### Non Patent Literature

Non Patent Literature 1: Kishino, et.al, “Detecting garbage collection duration using motion sensors mounted on a garbage truck toward smart waste management”, SPWID17

Non Patent Literature 2: Kishino, et.al, “Datafying city: detecting and accumulating spatio-temporal events by vehicle-mounted sensors”, BIGDATA 2017.

### SUMMARY

### Technical Problem

However, in the conventional technology, since inference operation processing is performed on all pieces of input data, it is difficult to mount neural network processing on a small embedded device having a large restriction on power consumption. Therefore, it is difficult to increase the speed of the inference operation processing while reducing the power consumption accompanying the inference operation processing.

Embodiments of the present invention has been made to solve the above-described problems, and an object thereof is to provide an inference processing technology capable of increasing the speed of inference operation processing while reducing power consumption accompanying the inference operation processing.

### Solution to Problem

In order to solve the above-described problem, an inference processing device according to embodiments of the present invention is an inference processing device that uses a learned neural network to infer a feature of input data, the inference processing device including: a first storage unit that stores the input data; a second storage unit that stores a weight of the learned neural network; a data filtering unit that extracts only specific input data from pieces of the input data that have been received; and an inference operation unit that uses the specific input data extracted by the data filtering unit and the weight as inputs, performs inference operation of the learned neural network, and infers the feature of the input data.

### Advantageous Effects of Embodiments of Invention

According to embodiments of the present invention, it is possible to increase the speed of the inference operation processing while reducing the power consumption accompanying the inference operation processing.

### BRIEF DESCRIPTION OF THE DRAWINGS

FIG. 1 is a block diagram illustrating a configuration of an inference processing device according to a first embodiment.

FIG. 2A is a block diagram illustrating a configuration of a data filtering unit in the inference processing device according to the first embodiment.

FIG. 2B is a diagram for explaining processing of the data filtering unit in the inference processing device according to the first embodiment.

FIG. 3 is a block diagram illustrating another configuration of the inference processing device according to the first embodiment.

FIG. 4 is a block diagram illustrating a configuration of the inference processing device according to the first embodiment.

FIG. 5 is a block diagram illustrating a configuration of the inference processing device according to the first embodiment.

FIG. 6 is a flowchart illustrating operation of the data filtering unit in the inference processing device according to the first embodiment.

FIG. 7 is a block diagram illustrating a configuration of an inference processing device according to a second embodiment.

FIG. 8 is a block diagram illustrating a configuration of the inference processing device according to the second embodiment.

FIG. 9 is a block diagram illustrating a configuration of the inference processing device according to the second embodiment.

FIG. 10 is a block diagram illustrating a configuration of an inference processing device according to a third embodiment.

FIG. 11 is a block diagram illustrating a configuration of a data filtering unit in the inference processing device according to the third embodiment.

FIG. 12 is a block diagram illustrating a configuration of the inference processing device according to the third embodiment.

FIG. 13 is a block diagram illustrating a configuration of the inference processing device according to the third embodiment.

FIG. 14 is a flowchart illustrating operation of the data filtering unit in the inference processing device according to the third embodiment.

FIG. 15 is a block diagram illustrating a configuration of an inference processing device according to a fourth embodiment.

FIG. 16 is a block diagram illustrating a configuration of the inference processing device according to the fourth embodiment.

FIG. 17 is a block diagram illustrating a configuration of the inference processing device according to the fourth embodiment.

FIG. 18 is a block diagram illustrating a configuration of an inference processing device according to a fifth embodiment.

FIG. 19 is a flowchart illustrating operation of a data filtering unit in the inference processing device according to the fifth embodiment.

FIG. 20 is a block diagram illustrating a hardware configuration of the inference processing device according to the embodiments of the present invention.

FIG. 21 is a block diagram illustrating a configuration of a conventional inference processing device.

### DETAILED DESCRIPTION OF ILLUSTRATIVE EMBODIMENTS

Hereinafter, preferred embodiments of the present invention will be described with reference to the drawings. The present invention is not limited to the following embodiments.

### First Embodiment

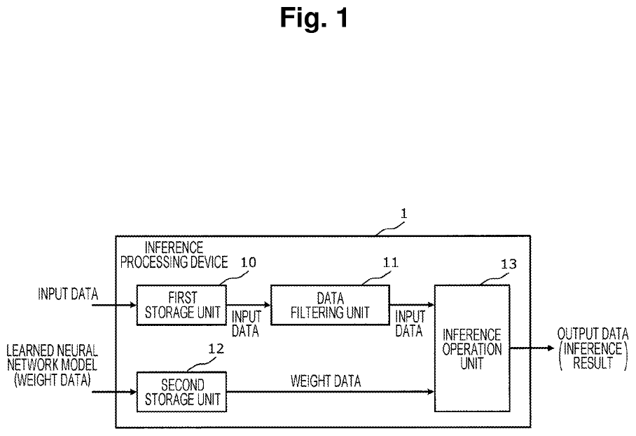

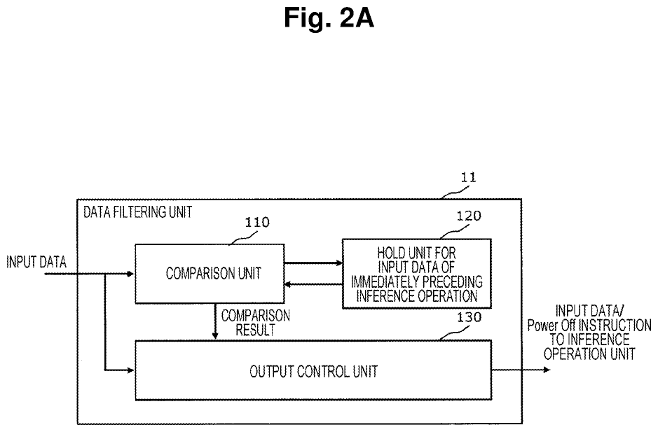

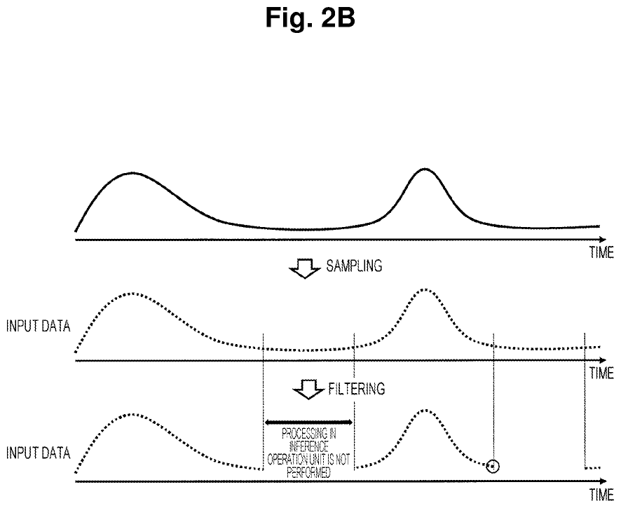

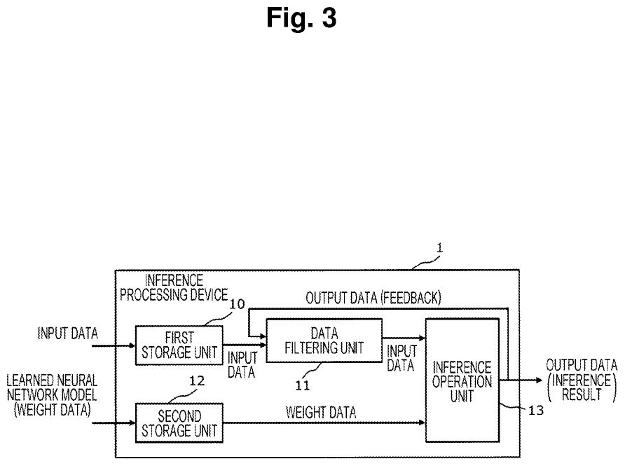

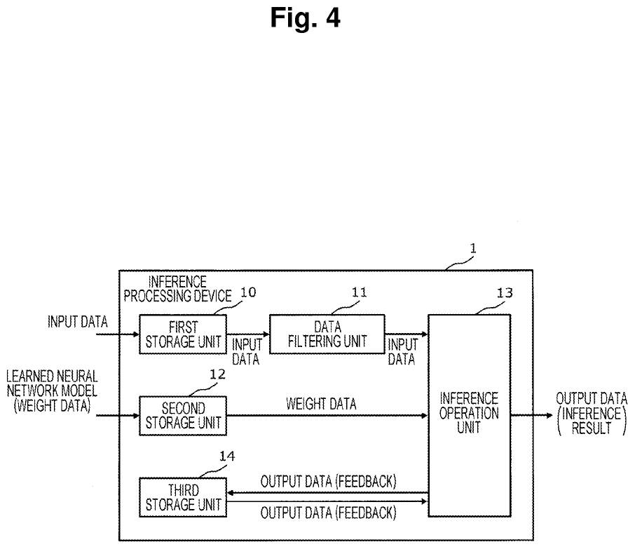

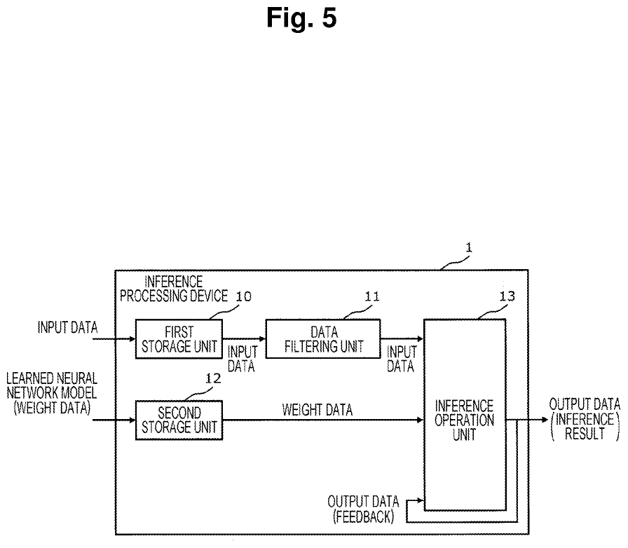

A configuration of an inference processing device according to a first embodiment of the present invention will be described with reference to FIGS. 1 to 5. FIG. 1 is a block diagram illustrating a configuration of the inference processing device according to the first embodiment. FIG. 2A is a block diagram illustrating a configuration of a data filtering unit in the inference processing device according to the first embodiment. FIG. 2B is a diagram for explaining processing of the data filtering unit according to the first embodiment. FIG. 3 is a block diagram illustrating another configuration of the inference processing device according to the first embodiment. FIG. 4 is a block diagram illustrating a configuration of the inference processing device according to the first embodiment. FIG. 5 is a block diagram illustrating a configuration of the inference processing device according to the first embodiment.

An inference processing device 1 of embodiments of the present invention performs inference processing on unknown input data using a neural network model obtained by learning a value of a weight using predetermined learning data as a whole. Time-series data such as audio data and language data acquired from the outside of the inference processing device 1 of embodiments of the present invention, or image data is used as input data to be inferred. The inference processing device 1 performs batch processing of operations of the neural network by using the learned neural network model, and infers a feature of the input data.

More specifically, the inference processing device 1 uses a neural network model obtained by performing learning in advance using input data such as time-series data in which an event at each time is known. The inference processing device 1 estimates an event at each time by using input data such as unknown time-series data and weight data of a learned neural network as inputs. The input data and the weight data are matrix data.

For example, the inference processing device 1 can use input data acquired from a sensor equipped with an acceleration sensor and a gyro sensor to detect an event such as rotation or stop of a garbage collection vehicle, thereby estimating the amount of garbage (see Non Patent Literature 1).

The inference processing device 1 includes: a first storage unit 10 that stores input data; a second storage unit 12 that stores a weight of a learned neural network; a data filtering unit 11 that extracts only specific data from pieces of the input data and uses the specific data as input data to an inference operation unit 13; and the inference operation unit 13 that uses the input data that has been extracted by the data filtering unit 11 and a weight of the learned neural network as inputs, performs inference operation of the learned neural network, and infers a feature of input data.

The first storage unit 10 has a function of storing input data. The second storage unit 12 has a function of storing a learned neural network model, that is, weight data.

The inference operation unit 13 has a function of performing operation of the neural network using the input data, weight data, and output data as inputs and outputting a result thereof. The inference operation unit 13 does not perform the inference operation processing in a period in which the input data is not input.

In this case, clock supply to the inference operation unit may be stopped (clock gating) or power supply may be stopped (power gating), and the power consumption is reduced. During a period in which the inference operation processing is not performed, the inference operation unit 13 may output an immediately preceding inference result to the outside such as a host device or a user device without performing the operation processing.

The data filtering unit 11 has a function of extracting only specific data from pieces of the input data and inputting the data to the inference operation unit 13. Specifically, similarity between the input data and data of previous inference operation is determined, and input data that is not similar is extracted and input to the inference operation unit 13. Since a configuration is made in which the similarity of the input data is determined and the inference operation processing for similar pieces of input data having the same result of the inference operation processing does not need to be performed, it is not necessary to perform the inference operation processing for all pieces of input data, and the speed of the inference operation processing can be increased while reducing the power consumption accompanying the inference operation processing.

For example, as illustrated in FIG. 2A, a holding unit 120 holds input data used in the immediately preceding inference processing and outputting of the inference result performed by the inference operation unit 13, a comparison unit 110 compares input data with the input data used in the immediately preceding inference processing and outputting of the inference result performed by the inference operation unit 13, and an output control unit 130 determines whether to output the input data to the inference operation unit 13 on the basis of the comparison result.

In the output control unit 130, when the difference between the input data and the input data used in the immediately preceding inference processing and outputting of the inference result is equal to or greater than a threshold, the input data is input to the inference operation unit 13. On the other hand, when the difference is less than the threshold, the input data is not input to the inference operation unit 13, and as the inference result at the time in this case, the inference result obtained by the immediately preceding inference processing performed by the inference operation unit 13 is used.

In FIG. 2A, input data is compared with input data used in the immediately preceding inference operation. However, a plurality of pieces of input data in the previous inference operation may be held, and the plurality of pieces of held data and the input data may be compared to determine whether to input the input data to the inference operation unit 13. For example, in a case where a difference between the input data and any one of the plurality of pieces of held data is less than the threshold, the input data may not be input to the inference operation unit 13.

FIG. 2B is a diagram for explaining processing of the data filtering unit according to the first embodiment. The data filtering unit 11 can be configured such that the inference operation processing in the inference operation unit 13 for similar pieces of data does not need to be performed by using the similarity of the input data by using the fact that the result obtained by the inference operation processing in the subsequent stage for similar input data does not change. As a result, an effect of increasing the speed of the inference operation processing while reducing the power consumption accompanying the inference operation processing can be obtained.

In a case where the input data includes a plurality of elements, for example, a plurality of pieces of data acquired from a sensor equipped with an acceleration sensor and a gyro sensor, in the comparison of the input data in the data filtering unit 11, it is sufficient that the comparison is performed using a first threshold for each element of the input data, determination is made that the input data is input to the inference operation unit 13 when the number of elements having a difference equal to or greater than the first threshold is equal to or greater than the second threshold, and determination is made that the input data is not input to the inference operation unit 13 when the number of elements having a difference equal to or greater than the first threshold is less than the second threshold.

In the above example, the difference comparison is performed using only the input data, but the data to be compared is not limited to the input data. For example, as illustrated in FIG. 3, when the input data and the inference result output by the inference operation unit 13 in the previous cycle are used as feedback, the feedback data, that is, the output data may be used as input data to the data filtering unit 11 to perform comparison. In this case, a logical sum or a logical product of the respective comparison results is calculated to determine the presence/absence of a difference.

In the above example, the inference operation is performed using the input data and the weight data, but the method of the inference operation processing is not limited thereto. For example, as illustrated in FIG. 4, the inference operation result may be used as an input of the inference operation processing of the next cycle, that is, output feedback may be performed.

In this case, the inference processing device 1 further includes a third storage unit 14 that holds output data fed back from the inference operation unit 13. By performing output feedback, there is an effect that it is possible to perform inference operation suitable for time-series data such as a character string and audio/language processing. As illustrated in FIG. 5, the output feedback may be directly fed back in the inference operation unit 13 instead of being input to the third storage unit 14, which has an effect of reducing the memory capacity mounted on the inference processing device 1.

The data amount may be reduced by making the sampling period long with respect to the input data in the data filtering unit 11.

In the above example, the input data is compared with the input data used in the immediately preceding inference processing and outputting of the inference result performed in the inference operation unit 13, but the data to be compared is not limited thereto. For example, an inference result obtained by inference processing in the inference operation unit 13 in a predetermined number of cycles before and thereafter and input data used for the inference processing are stored, and the input data is compared with the input data in the predetermined number of cycles before.

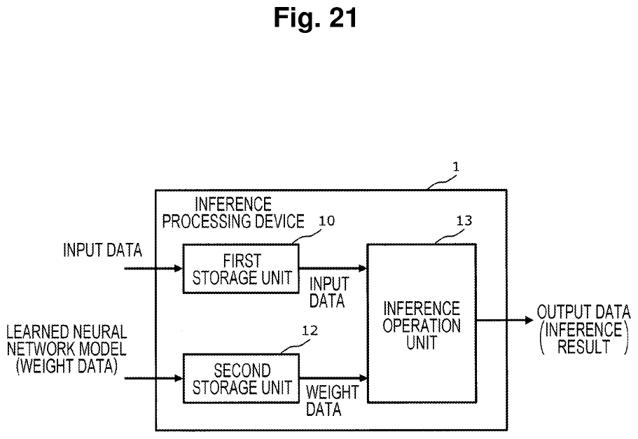

A difference from the conventional inference processing device 1 illustrated in FIG. 21 is that the inference processing device 1 of embodiments of the present invention includes the data filtering unit 11. While the conventional inference processing device 1 performs inference operation processing on all pieces of input data, the inference processing device 1 of embodiments of the present invention extracts only specific input data in the data filtering unit 11.

### Operation of First Embodiment

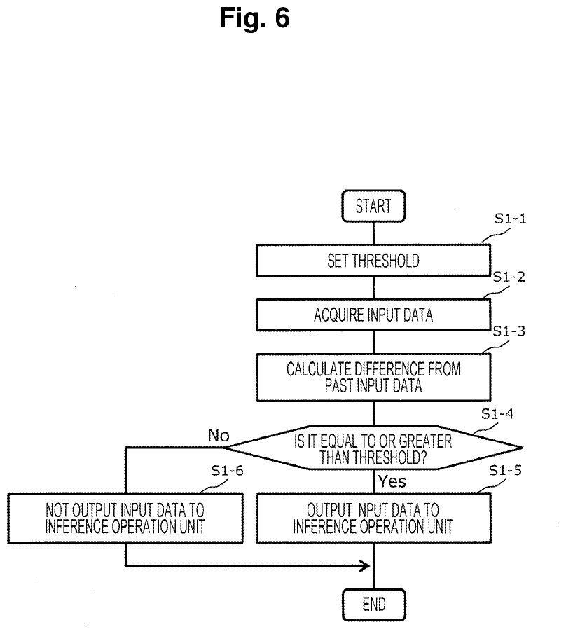

Next, operation of the data filtering unit 11 in the inference processing device 1 according to the first embodiment will be described with reference to FIG. 6. FIG. 6 is a flowchart illustrating operation of the data filtering unit in the inference processing device according to the first embodiment.

First, the data filtering unit 11 sets a threshold used to detect a difference between input data and input data in the past inference operation processing (step S1-1). The threshold may be set in advance at the time of starting the operation as an initial setting, or the threshold may be dynamically changed during the operation.

For example, when there is no difference in the obtained inference processing result with respect to a threshold used at a certain time, the threshold may be increased. When the inference accuracy with respect to the inference processing result is lower than the desired accuracy, the threshold is reduced, and thereby, the inference processing is performed on a larger amount of input data. As a result, it can be expected that the accuracy can be improved. As described above, the threshold used for similarity comparison of the input data may be dynamically set according to the inference operation result.

Next, the data filtering unit 11 acquires input data and input data of the immediately preceding inference operation (step S1-2), and calculates a difference from past input data of the previous inference operation processing (step S1-3). As the past input data, for example, input data in the immediately preceding input and inference processing can be used.

When the calculated difference is compared with the threshold and the difference thereof is equal to or greater than the threshold (step S1-4: Yes), the input data is output to the inference operation unit 13 (step S1-5). On the other hand, when the difference is less than the threshold (step S1-4: No), the input data is not output to the inference operation unit 13 (step S1-6). As the inference result in this case, an inference result obtained by inference processing performed by the inference operation unit 13 using past input data is used.

As described above, since the result obtained by the inference operation processing in the subsequent stage for similar input data does not change, the data filtering unit 11 can be configured to determine the similarity of the input data with respect to the data of the past inference operation, and not to output the input data similar to the past input data to the inference operation unit 13. As a result, the inference operation unit 13 does not need to perform inference operation processing on input data similar to the input data of the past inference operation, and thus, it is possible to achieve an increase in speed of the inference operation processing and a reduction in power consumption accompanying the inference operation processing.

### Effects of First Embodiment

As described above, in the inference processing device of the present embodiment, in order to perform inference processing with respect to unknown input data by using a neural network obtained by learning a value of a weight by using predetermined learning data, the first storage unit 10 stores the input data, the second storage unit 12 stores a weight of the learned neural network, the data filtering unit 11 extracts only specific data from pieces of the input data and uses the specific data as input data to the inference operation unit 13, and the inference operation unit 13 uses the input data extracted by the data filtering unit 11 and the weight of the learned neural network as inputs, performs inference operation of the learned neural network, and infers the feature of the input data.

As a result, the data filtering unit 11 can be configured to determine the similarity of the input data by using the fact that the result obtained by the inference operation processing in the subsequent stage for similar input data does not change so that the inference operation processing for similar data does not need to be performed. The inference processing device 1 of embodiments of the present invention can increase the speed of inference operation processing and reduce power consumption accompanying the inference operation processing, as compared with a conventional inference processing device that performs inference processing on all pieces of input data. Since the inference processing does not need to be performed on all pieces of input data, the output of the inference result from the inference processing device 1 can also be reduced, so that the load on the communication network can also be reduced.

### Second Embodiment

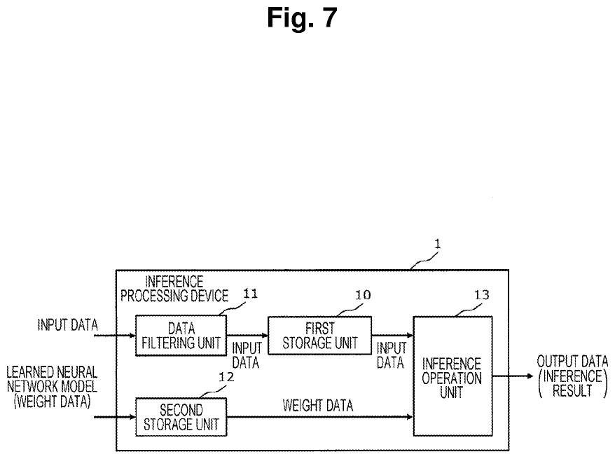

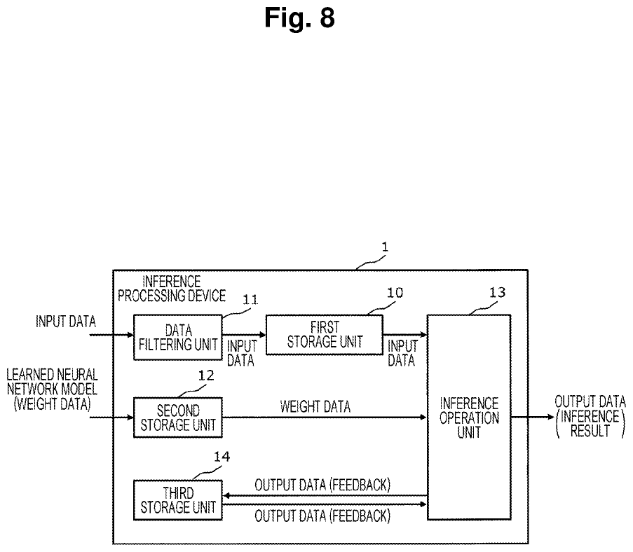

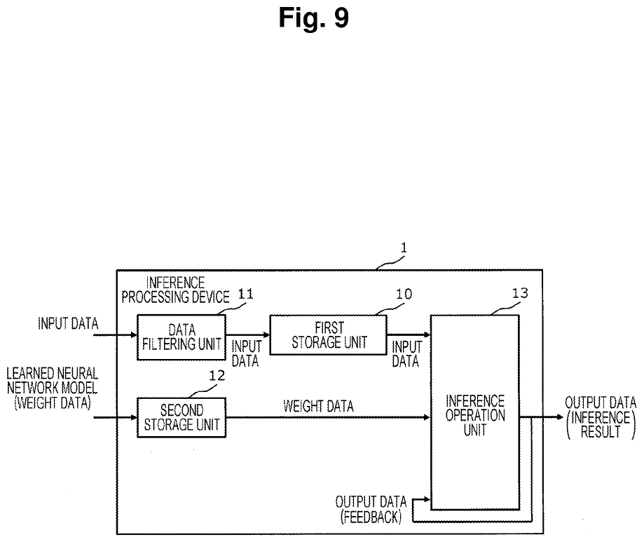

An inference processing device 1 according to a second embodiment of the present invention will be described with reference to FIGS. 7 to 9. FIG. 7 is a block diagram illustrating a configuration of the inference processing device according to the second embodiment. FIG. 8 is a block diagram illustrating a configuration of the inference processing device according to the second embodiment. FIG. 9 is a block diagram illustrating a configuration of the inference processing device according to the second embodiment.

A difference from the first embodiment is that a data filtering unit 11 is provided in a preceding stage of a storage unit, and only specific data from pieces of input data is extracted and then stored in the storage unit. In this case, a memory control unit determines the presence or absence of the input data stored in the storage unit, that is, the input data waiting for the inference operation processing, and inputs the input data to the inference operation unit 13 in the subsequent stage. As described above, by arranging the data filtering unit 11 in the preceding stage of a first storage unit 10, there is an effect that the memory amount used by the first storage unit 10 can be reduced.

In the above example, the inference operation is performed using the input data and the weight data, but the method of the inference operation processing is not limited thereto. For example, as illustrated in FIG. 8, the inference operation result may be used as an input of the inference operation processing of the next cycle, that is, output feedback may be performed. By performing output feedback, there is an effect that it is possible to perform inference operation suitable for time-series data such as a character string and audio/language processing. As illustrated in FIG. 9, the output feedback may be directly fed back in the inference operation unit 13 instead of being input to the storage unit, which has an effect of reducing the memory capacity consumed in the storage unit.

### Effects of Second Embodiment

As described above, in the present embodiment, in order to perform inference processing with respect to unknown input data by using a neural network obtained by learning a value of a weight by using predetermined learning data, the first storage unit 10 stores the input data, the second storage unit 12 stores a weight of the learned neural network, the data filtering unit 11 extracts only specific input data from pieces of the input data and uses the specific data as input data to the inference operation unit 13, and the inference operation unit 13 uses the input data extracted by the data filtering unit 11 and the weight of the learned neural network as inputs, performs inference operation of the learned neural network, and infers the feature of the input data.

As a result, the data filtering unit 11 can be configured to determine the similarity of the input data so that it is not necessary to perform the inference operation processing for input data similar to input data of past inference operation. The inference processing device 1 of embodiments of the present invention can increase the speed of inference operation processing and reduce power consumption accompanying the inference operation processing, as compared with a conventional inference processing device that performs inference processing on all pieces of input data.

By arranging the data filtering unit 11 in the preceding stage of a first storage unit 10, there is an effect that the memory amount used by the first storage unit 10 can be reduced.

Since the inference processing does not need to be performed on all pieces of input data, the output of the inference result from the inference processing device 1 can also be reduced, so that the load on the communication network can be reduced.

### Third Embodiment

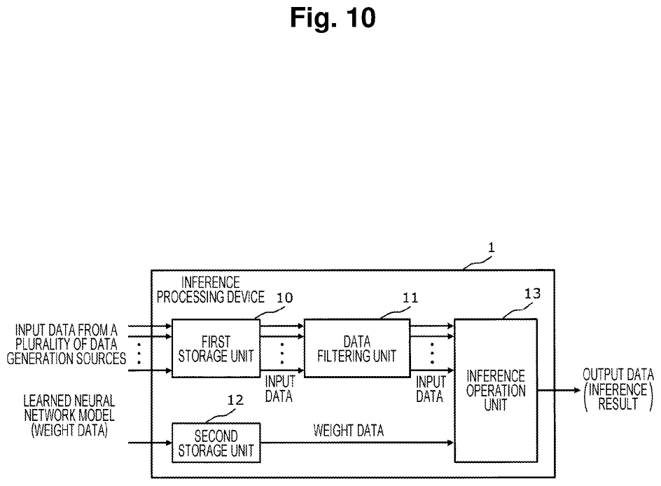

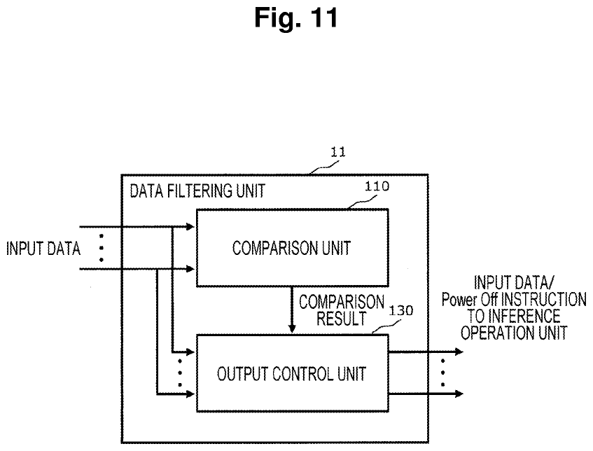

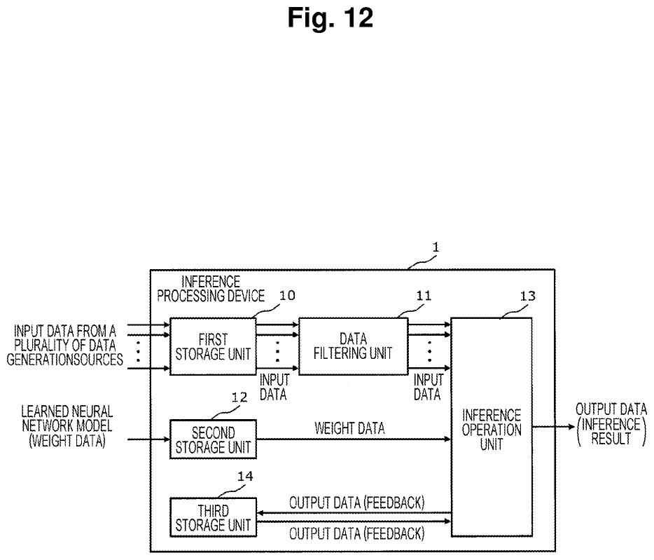

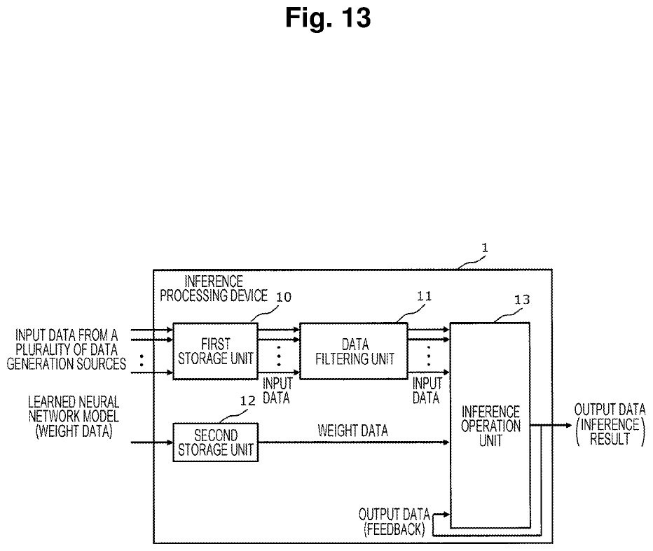

A configuration of an inference processing device 1 according to a third embodiment of the present invention will be described with reference to FIGS. 10 to 13. FIG. 10 is a block diagram illustrating a configuration of the inference processing device according to the third embodiment. FIG. 11 is a block diagram illustrating a configuration of a data filtering unit in the inference processing device according to the third embodiment. FIG. 12 is a block diagram illustrating a configuration of the inference processing device according to the third embodiment. FIG. 13 is a block diagram illustrating a configuration of the inference processing device according to the third embodiment.

A difference from the first and second embodiments is that the third embodiment is an inference processing device 1 that receives input data from a plurality of data generation sources, performs inference operation processing on the input data, and outputs an inference result, and further includes a data filtering unit 11 that detects similarity between a plurality of pieces of input data that are at the same time.

The data filtering unit has a function of extracting only specific data from a plurality of pieces of the input data and inputting the data to the inference operation unit 13. Specifically, as illustrated in FIG. 11, a plurality of pieces of input data are compared with each other, and in a case where the difference thereof is equal to or less than a threshold, inference operation processing is performed only on one of the compared pieces of input data. In this case, as the inference result of the input data for which the inference operation processing has not been performed, the same inference result obtained by performing the inference processing on the compared input data by the inference operation unit 13 is used. On the other hand, when the difference is greater than the threshold, the output results of the inference operation processing of both pieces of input data are different, and thus the inference operation processing is performed on both.

As described above, the data filtering unit 11 detects the similarity between pieces of input data of the plurality of different input data generation sources, and the results obtained by the inference operation processing in the subsequent stage on the similar pieces of input data are the same, so that it is not necessary to perform the inference operation processing. As a result, an effect of increasing the speed of the inference operation processing and reducing the power consumption accompanying the inference operation processing can be obtained.

The pieces of input data to be compared are determined in a predetermined combination. As the predetermined combination, for example, pieces of input data having the closest physical distance of the generation sources of the pieces of input data are compared with each other, or pieces of input data corresponding to the order of identifiers given to the generation sources of the pieces of input data are compared with each other.

The number of times of comparing pieces of input data is not limited to one stage, and comparison may be performed a plurality of times with a combination of different pieces of input data.

The inference operation unit 13 may perform inference processing for a plurality of pieces of input data in parallel. As a result, an effect of increasing the speed of the inference operation processing can be obtained.

In the above example, the pieces of input data to be compared is an example of comparing pieces of input data from predetermined input sources, but the pieces of input data may not be specific pieces of input data. That is, arbitrary pieces of input data may be compared with each other. For example, when the terminal or the like of the input data generation source is a mobile terminal that physically moves with respect to time, the mobile terminals physically close in distance at that time may be combined to compare the input data.

In the above example, the input data is reduced in order to increase the speed and reduce the power consumption of the inference processing. For this reason, the example in which the similarity is not exhaustively searched for all the combinations of the input data, but the similarity is compared only for some combinations of the input data has been described, but the similarity detection method is not necessarily limited thereto.

For example, comparing the similarity in all combinations with respect to the generation source of the input data input to the inference processing device 1 can be performed at a higher speed than the inference processing in the subsequent stage, and when the power required for detecting the similarity is lower than the inference processing in the subsequent stage, the similarity may be comprehensively searched for to achieve the inference processing at a higher speed and a lower power consumption.

In the above example, the threshold used to detect the similarity is provided as the initial setting, but the method of setting the threshold is not limited thereto. For example, when there is no difference in the obtained inference processing result with respect to a threshold used at a certain time, the threshold may be increased. When the inference accuracy with respect to the inference processing result is lower than the desired accuracy, the inference processing is performed on a larger amount of input data by reducing the threshold, and thus, it can be expected that the accuracy can be improved. As described above, the threshold used for similarity comparison of the input data may be dynamically set according to the inference operation result.

In the above example, the inference operation is performed using the input data and the weight data, but the method of the inference operation processing is not limited thereto. For example, as illustrated in FIG. 12, the inference operation result may be used as an input of the inference operation processing of the next cycle, that is, output feedback may be performed. By performing output feedback, there is an effect that it is possible to perform inference operation suitable for time-series data such as a character string and audio/language processing. As illustrated in FIG. 13, the output feedback may be directly fed back in the inference operation unit 13 instead of being input to the storage unit, which has an effect of reducing the memory capacity consumed in the storage unit.

In the above example, there is one piece of output data, but there may be a plurality of pieces of output data.

### Operation of Third Embodiment

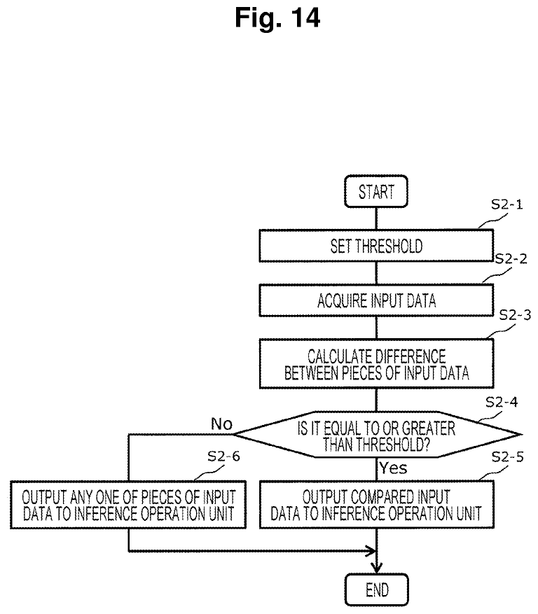

Next, operation of the data filtering unit 11 in the inference processing device 1 according to the third embodiment will be described with reference to FIG. 14. FIG. 14 is a flowchart illustrating operation of the data filtering unit in the inference processing device according to the third embodiment.

A difference from the first and second embodiments is that pieces of input data from a plurality of data generation sources are received, similarity between the plurality of pieces of input data is determined, and specific input data is extracted from the pieces of input data on the basis of the similarity.

First, the data filtering unit 11 sets a threshold used to detect similarity between a plurality of pieces of input data (step S2-1). The threshold may be set in advance at the time of starting the operation as an initial setting, or the threshold may be dynamically changed during the operation.

For example, when there is no difference in the obtained inference processing result with respect to a threshold used at a certain time, the threshold may be increased. When the inference accuracy with respect to the inference processing result is lower than the desired accuracy, the threshold is reduced, and thereby, the inference processing is performed on a larger amount of input data. As a result, it can be expected that the accuracy can be improved. As described above, the threshold used for similarity comparison of the input data may be dynamically set according to the inference operation result.

Next, the data filtering unit 11 acquires input data from a plurality of data generation sources (step S2-2) and calculates a difference (S2-3). When the calculated difference is equal to or greater than the threshold (step S2-4: Yes), output results of the inference operation processing on a plurality of pieces of input data are different, and thus the inference operation processing is performed on a plurality of pieces of input data (step S2-5).

On the other hand, when the calculated difference is less than the threshold (step S2-4: No), the inference operation processing is performed only on one of the compared pieces of input data (step S2-6). In this case, as the inference result of the other piece of input data for which the inference operation processing has not been performed, the same inference result obtained by performing the inference processing on the compared input data by the inference operation unit 13 is used.

As a result, since the results obtained by the inference operation processing in the subsequent stage on similar pieces of input data are the same, the data filtering unit 11 can be configured to determine the similarity of pieces of input data of a plurality of different input data generation sources, and not to perform the inference operation processing on all pieces of similar input data. As a result, it is possible to increase the speed of the inference operation processing and reduce the power consumption accompanying the inference operation processing.

### Effects of Third Embodiment

As described above, in the present embodiment, in order to perform inference processing with respect to unknown input data by using a neural network that has learned a value of a weight by using predetermined learning data, the first storage unit 10 stores input data from a plurality of data generation sources, the second storage unit 12 stores a weight of the learned neural network, the data filtering unit 11 detects similarity between a plurality of pieces of input data that are at the same time, extracts only specific input data from pieces of the input data, and uses the specific input data as input data to the inference operation unit 13, and the inference operation unit 13 uses the input data extracted by the data filtering unit 11 and the weight of the learned neural network as inputs, performs inference operation of the learned neural network, and infers the feature of the input data.

As a result, the data filtering unit 11 detects the similarity between pieces of input data of the plurality of different input data generation sources so that it is not necessary to perform the inference operation processing in the subsequent stage on similar pieces of input data having the same result of the inference operation processing. The inference processing device 1 of embodiments of the present invention can increase the speed of inference operation processing and reduce power consumption accompanying the inference operation processing, as compared with a conventional inference processing device that performs inference processing on all pieces of input data.

Since the inference processing does not need to be performed on all pieces of input data, the output of the inference result from the inference processing device 1 can also be reduced, so that the load on the communication network can be reduced.

### Fourth Embodiment

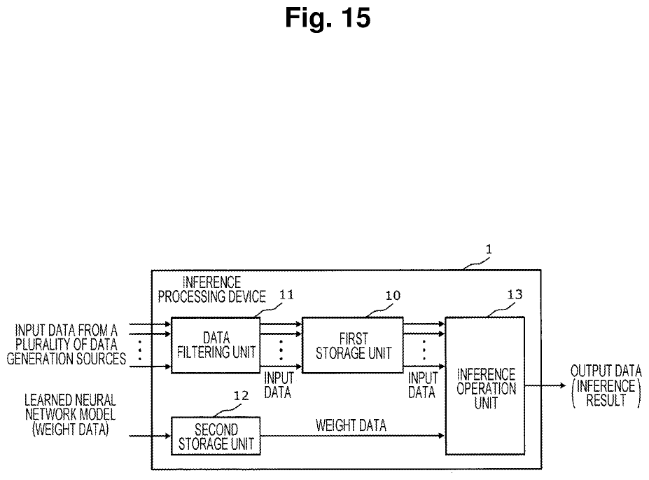

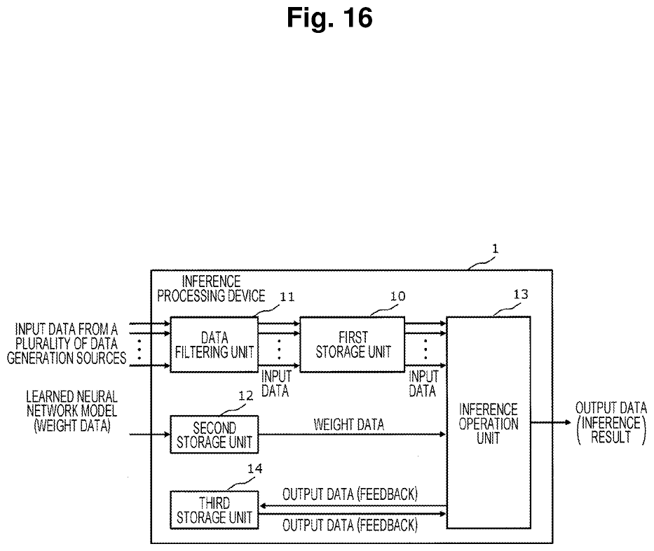

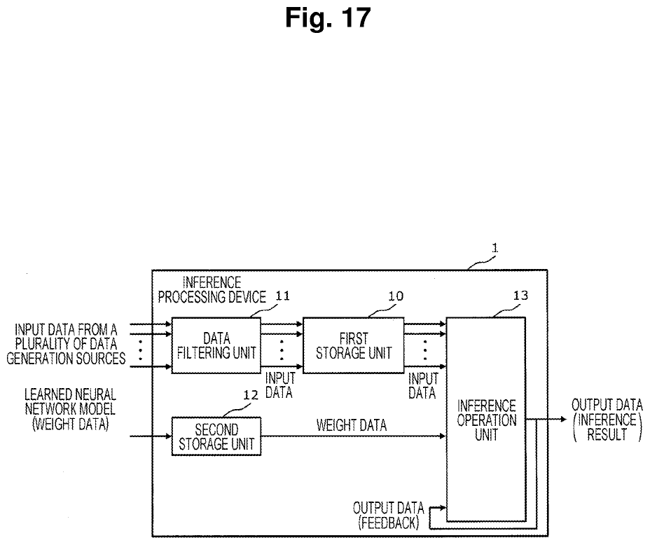

An inference processing device 1 according to a fourth embodiment of the present invention will be described with reference to FIGS. 15 to 17. FIG. 15 is a block diagram illustrating a configuration of the inference processing device according to the fourth embodiment. FIG. 16 is a block diagram illustrating a configuration of the inference processing device according to the fourth embodiment. FIG. 17 is a block diagram illustrating a configuration of the inference processing device according to the fourth embodiment.

The difference from the first to third embodiments is that the inference processing device 1 of the present embodiment includes a data filtering unit 11 in a preceding stage of a storage unit, extracts only specific data from pieces of input data and then stored in a first storage unit 10, receives pieces of input data from a plurality of data generation sources, and performs inference operation processing on the pieces of input data, the inference processing device 1 further detecting similarity between a plurality of pieces of input data that are at the same time.

In the above example, the inference operation is performed using the input data and the weight data, but the method of the inference operation processing is not limited thereto. For example, as illustrated in FIG. 16, the inference operation result may be used as an input of the inference operation processing of the next cycle, that is, output feedback may be performed. By performing output feedback, there is an effect that it is possible to perform inference operation suitable for time-series data such as a character string and audio/language processing. As illustrated in FIG. 17, the output feedback may be directly fed back in the inference operation unit 13 instead of being input to the storage unit, which has an effect of reducing the memory capacity consumed in the storage unit.

### Effects of Fourth Embodiment

As described above, in the present embodiment, in order to perform inference processing with respect to unknown input data by using a neural network that has learned a value of a weight by using predetermined learning data, the first storage unit 10 stores input data from a plurality of data generation sources, the second storage unit 12 stores a weight of the learned neural network, the data filtering unit 11 detects similarity between a plurality of pieces of input data that are at the same time, extracts only specific input data from pieces of the input data, and uses the specific input data as input data to the inference operation unit 13, and the inference operation unit 13 uses the input data extracted by the data filtering unit 11 and the weight of the learned neural network as inputs, performs inference operation of the learned neural network, and infers the feature of the input data.

As a result, the data filtering unit 11 detects the similarity between pieces of input data of the plurality of different input data generation sources so that it is not necessary to perform the inference operation processing in the subsequent stage on similar pieces of input data having the same result of the inference operation processing. The inference processing device 1 of embodiments of the present invention can increase the speed of inference operation processing and reduce power consumption accompanying the inference operation processing, as compared with a conventional inference processing device that performs inference processing on all pieces of input data.

By arranging the data filtering unit 11 in the preceding stage of a first storage unit 10, there is an effect that the memory amount used by the first storage unit 10 can be reduced. Since the inference processing does not need to be performed on all pieces of input data, the output of the inference result from the inference processing device 1 can also be reduced, so that the load on the communication network can be reduced.

### Fifth Embodiment

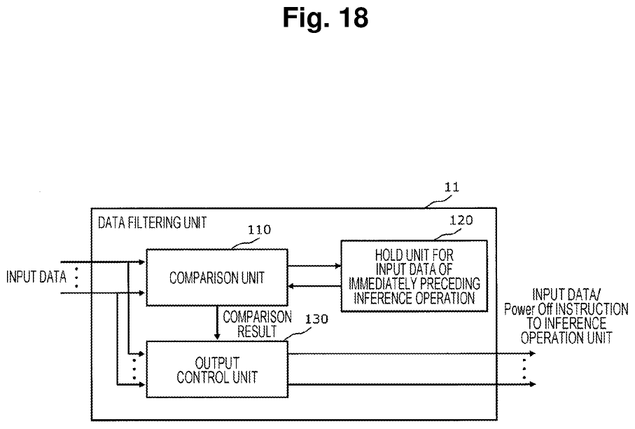

An inference processing device 1 according to a fifth embodiment of the present invention will be described with reference to FIG. 18. FIG. 18 is a block diagram illustrating a configuration of a data filtering unit in the inference processing device according to the fifth embodiment.

A difference from the first to fourth embodiments is that a data filtering unit 11 detects, for pieces of input data from a plurality of data generation sources, both similarity between a plurality of pieces of input data that are at the same time and similarity between input data and input data used in the immediately preceding inference processing and outputting of an inference result by the inference operation unit 13.

The data filtering unit 11 has a function of extracting only specific data from a plurality of pieces of the input data and inputting the data to the inference operation unit 13. Specifically, as illustrated in FIG. 18, a plurality of pieces of input data are compared with each other, and in a case where the difference thereof is equal to or less than a threshold, one of the compared pieces of input data is extracted. Furthermore, the input data is compared with the input data used in the immediately preceding inference processing and outputting of the inference result by the inference operation unit 13, and when the difference thereof is equal to or greater than a threshold, the input data is input to the inference operation unit 13, and the inference operation processing is performed only on the input data.

In this case, as the inference result of the input data for which the inference operation processing has not been performed, the same inference result obtained by performing the inference processing on the compared input data by the inference operation unit 13 is used. On the other hand, in a case where the difference is less than the threshold, the input data is not input to the inference operation unit 13, and the inference result obtained by the inference processing performed by the inference operation unit 13 immediately before is used as the inference result at the time in this case.

When a plurality of pieces of input data are compared and the difference thereof is greater than the threshold, the output results of the inference operation processing of both pieces of input data are different, and thus the inference operation processing is performed on both. At this time, as similar to that, the input data is compared with the input data used in the immediately preceding inference processing and outputting of the inference result by the inference operation unit 13, and when the difference thereof is equal to or greater than a threshold, the input data is input to the inference operation unit 13, and the inference operation processing is performed only on the input data. In this case, as the inference result of the input data for which the inference operation processing has not been performed, the same inference result obtained by performing the inference processing on the compared input data by the inference operation unit 13 is used.

As described above, the data filtering unit 11 detects the similarity between pieces of input data of the plurality of different input data generation sources, and the results obtained by the inference operation processing in the subsequent stage on the similar pieces of input data are the same, so that it is not necessary to perform the inference operation processing. As a result, it is possible to increase the speed of the inference operation processing and reduce the power consumption accompanying the inference operation processing.

As described above, the data filtering unit 11 detects the similarity between pieces of input data, and the result obtained by the subsequent inference operation processing on the similar pieces of input data does not vary, so that it is not necessary to perform the inference operation processing. As a result, it is possible to increase the speed of the inference operation processing and reduce the power consumption accompanying the inference operation processing.

The pieces of input data to be compared are determined in a predetermined combination. As the predetermined combination, for example, pieces of input data having the closest physical distance of the generation sources of the pieces of input data are compared with each other, or pieces of input data corresponding to the order of identifiers given to the generation sources of the pieces of input data are compared with each other.

The number of times of comparing pieces of input data is not limited to one stage, and comparison may be performed a plurality of times with a combination of different pieces of input data.

The inference operation unit 13 may perform inference processing for a plurality of pieces of input data in parallel. As a result, an effect of increasing the speed of the inference operation processing can be obtained.

In the above example, the pieces of input data to be compared is an example of comparing pieces of input data from predetermined input sources, but the pieces of input data may not be specific pieces of input data. That is, arbitrary pieces of input data may be compared with each other. For example, when the terminal or the like of the input data generation source is a mobile terminal that physically moves with respect to time, the mobile terminals physically close in distance at that time may be combined to compare the input data.

In the above example, the input data is reduced in order to increase the speed and reduce the power consumption of the inference processing. For this reason, the example in which the similarity is not exhaustively searched for all the combinations of the input data, but the similarity is compared only for some combinations of the input data has been described, but the similarity detection method is not necessarily limited thereto.

For example, comparing the similarity in all combinations with respect to the generation source of the input data input to the inference processing device 1 can be performed at a higher speed than the inference processing in the subsequent stage, and when the power required for detecting the similarity is lower than the inference processing in the subsequent stage, the similarity may be comprehensively searched for to achieve the inference processing at a higher speed and a lower power consumption.

In the above example, the threshold used to detect the similarity is provided as the initial setting, but the method of setting the threshold is not limited thereto. For example, when there is no difference in the obtained inference processing result with respect to a threshold used at a certain time, the threshold may be increased. When the inference accuracy with respect to the inference processing result is lower than the desired accuracy, the inference processing is performed on a larger amount of input data by reducing the threshold, and thus, it can be expected that the accuracy can be improved. As described above, the threshold used for similarity comparison of the input data may be dynamically set according to the inference operation result.

In the above example, the inference operation is performed using the input data and the weight data, but the method of the inference operation processing is not limited thereto. For example, as illustrated in FIG. 16, the inference operation result may be used as an input of the inference operation processing of the next cycle, that is, output feedback may be performed. By performing output feedback, there is an effect that it is possible to perform inference operation suitable for time-series data such as a character string and audio/language processing.

As illustrated in FIG. 17, the output feedback may be directly fed back in the inference operation unit 13 instead of being input to the storage unit, which has an effect of reducing the memory capacity consumed in the storage unit.

In the above example, there is one piece of output data, but there may be a plurality of pieces of output data.

In the comparison of the input data, a first threshold is used for each element of the input data, and it is determined that there is a difference when an element having a difference equal to or greater than the first threshold is equal to or greater than a second threshold, and it is determined that there is no difference when an element having a difference equal to or greater than the first threshold is less than the second threshold.

In the above example, the difference comparison is performed using only the input data, but the data to be compared is not limited to the input data. For example, when the input data and the inference result output by the inference operation unit 13 in the previous cycle are used as feedback, the comparison may be performed on the feedback data, that is, the output data. In this case, a logical sum or a logical product of the respective comparison results is calculated to determine the presence/absence of a difference.

In the above example, the similarity of the input data is detected by comparing the difference of pieces of input data, but the method of detecting the difference is not limited thereto.

In the above example, the inference operation is performed using the input data and the weight data, but the method of the inference operation processing is not limited thereto. For example, as illustrated in FIG. 4, the inference operation result may be used as an input of the inference operation processing of the next cycle, that is, output feedback may be performed. In this case, the inference processing device 1 further includes a third storage unit 14 that holds output data fed back from the inference operation unit 13. By performing output feedback, there is an effect that it is possible to perform inference operation suitable for time-series data such as a character string and audio/language processing.

As illustrated in FIG. 5, the output feedback may be directly fed back in the inference operation unit 13 instead of being input to the third storage unit 14, which has an effect of reducing the memory capacity mounted on the inference processing device 1.

In the above example, an example of comparing the input data with the input data used in the immediately preceding inference processing and outputting of the inference result performed in the inference operation unit 13 has been described, but the data to be compared is not limited thereto. For example, an inference result obtained by inference processing in the inference operation unit 13 in a predetermined number of cycles before and thereafter and input data used for the inference processing are stored, and the input data is compared with the input data in the predetermined number of cycles before.

### Operation of Fifth Embodiment

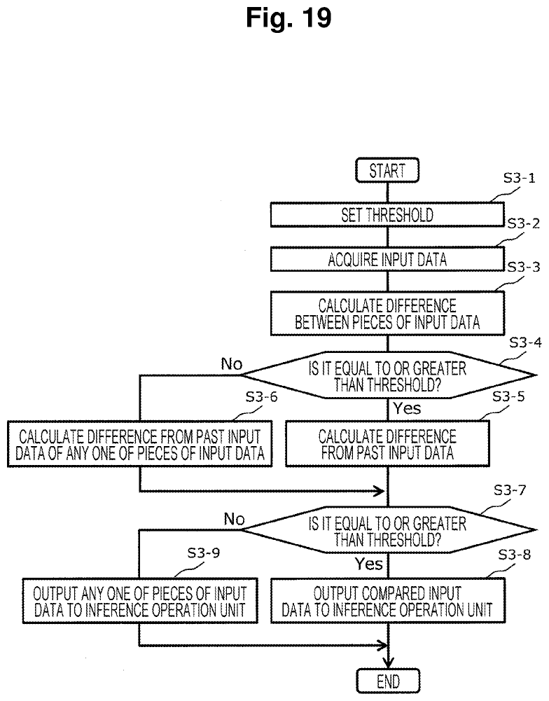

Next, operation of the data filtering unit 11 in the inference processing device 1 according to the fifth embodiment will be described with reference to FIG. 19. FIG. 19 is a flowchart illustrating operation of the data filtering unit in the inference processing device according to the fifth embodiment.

A difference from the first to fourth embodiments is that specific input data is extracted from pieces of input data on the basis of determination results of both determination of similarity with past input data of previous inference operation and determination of similarity between a plurality of pieces of input data that are at the same time by receiving pieces of input data from a plurality of data generation sources. By determining the similarity between both of the above, it is possible to further reduce the input data for which the inference operation is performed.

First, the data filtering unit 11 sets a threshold used for detecting similarity between a plurality of pieces of input data and a threshold used to detect a difference between input data and input data in the past inference operation processing (step S3-1). The threshold may be set in advance at the time of starting the operation as an initial setting, or the threshold may be dynamically changed during the operation.

For example, when there is no difference in the obtained inference processing result with respect to a threshold used at a certain time, the threshold may be increased. When the inference accuracy with respect to the inference processing result is lower than the desired accuracy, the inference processing is performed on a larger amount of input data by reducing the threshold, and thus, it can be expected that the accuracy can be improved. As described above, the threshold used for similarity comparison of the input data may be dynamically set according to the inference operation result.

Next, the data filtering unit 11 acquires input data from a plurality of data generation sources (step S3-2) and calculates a difference (step S3-3). When the calculated difference is equal to or greater than the threshold (step S3-4: Yes), a difference from the past input data of the previous inference operation processing is further calculated (step S3-5), and it is determined whether to output the difference to the inference operation unit (step S3-7).

On the other hand, when the calculated difference is less than the threshold (step S3-4: No), a difference from the past input data of the previous inference operation processing is calculated only for one of the compared pieces of input data (step S3-6), and it is determined whether to output the difference to the inference operation unit 13 (step S3-7).

When the difference from the past input data of the inference operation processing is equal to or greater than the threshold (step S3-7: Yes), the input data is output to the inference operation unit 13 and inference operation is performed (step S3-8). On the other hand, when the difference is less than the threshold (step S3-7: No), the input data is not input to the inference operation unit 13, and inference is not performed (step S3-9). As the inference result at the time in this case, an inference result obtained by inference processing on past input data is used.

As described above, the data filtering unit 11 is configured to determine similarity of a plurality of pieces of input data and not to perform the inference operation processing on all similar pieces of input data, and is further configured to determine similarity with past input data of previous inference processing and not to perform the inference operation processing on data similar to the past input data of the previous inference processing. As a result, it is not necessary to perform inference operation processing in the subsequent stage on similar input data, and thus, it is possible to increase the speed of the inference operation processing and reduce the power consumption accompanying the inference operation processing.

### Effects of Fifth Embodiment

As described above, in the present embodiment, in order to perform inference processing with respect to unknown input data by using a neural network that has learned a value of a weight by using predetermined learning data, the first storage unit 10 stores input data from a plurality of data generation sources, the second storage unit 12 stores a weight of the learned neural network, the data filtering unit 11 determines similarity between a plurality of pieces of input data and similarity with past input data of previous inference processing, extracts only specific input data from pieces of the input data on the basis of the determination result of the similarity, and uses the specific data as input data to the inference operation unit 13, and the inference operation unit 13 uses the input data extracted by the data filtering unit 11 and the weight of the learned neural network as inputs, performs inference operation of the learned neural network, and infers the feature of the input data.

As a result, a configuration can be achieved in which the data filtering unit 11 determines the similarity between pieces of input data of the plurality of different input data generation sources and the similarity with past input data of previous inference processing so that it is not necessary to perform the inference operation processing in the subsequent stage on similar pieces of input data having the same result of the inference operation processing. Therefore, the inference processing device 1 of the present invention can increase the speed of inference operation processing and reduce power consumption accompanying the inference operation processing, as compared with a conventional inference processing device that performs inference processing on all pieces of input data.

By arranging the data filtering unit 11 in the preceding stage of a first storage unit 10, there is an effect that the memory amount used by the first storage unit 10 can be reduced. Since the inference processing does not need to be performed on all pieces of input data, the output of the inference result from the inference processing device 1 can also be reduced, so that the load on the communication network can be reduced.

### Hardware Configuration of Inference Processing Device

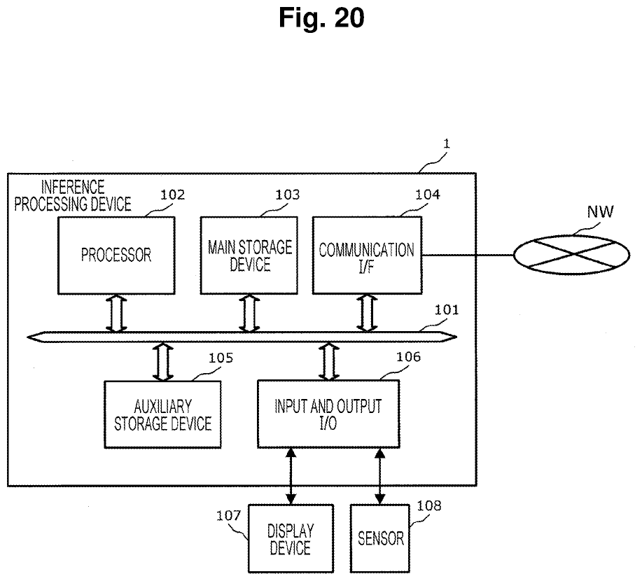

Next, an example of a hardware configuration of the inference processing device 1 having the above-described configuration will be described with reference to FIG. 20.

As illustrated in FIG. 20, the inference processing device 1 can be achieved by, for example, a computer including a processor 102, a main storage device 103, a communication interface 104, an auxiliary storage device 105, and an input and output I/O 106 connected via a bus 101, and a program for controlling these hardware resources. In the inference processing device 1, for example, the display device 107 may be connected via the bus 101, and the inference result or the like may be displayed on the display screen. Furthermore, the sensor 108 may be connected via the input and output I/O 106 and the bus 101, and the inference processing device 1 may measure input data X including time-series data such as audio data to be inferred.

The main storage device 103 is achieved by, for example, a semiconductor memory such as SRAM, DRAM, and ROM. The main storage device 103 implements the storage unit described in FIG. 1 and the like.

In the main storage device 103, a program for the processor 102 to perform various controls and operations is stored in advance. Each function of the inference processing device 1 including the first storage unit 10, the second storage unit 12, the data filtering unit 11, and the inference operation unit 13 illustrated in FIG. 1 and the like is achieved by the processor 102 and the main storage device 103.

The communication interface 104 is an interface circuit for communicating with various external electronic devices via the communication network NW. The inference processing device 1 may receive weight data W of the learned neural network from the outside via the communication interface 104 or may transmit an inference result Y to the outside.

As the communication interface 104, for example, an interface and an antenna compatible with wireless data communication standards such as LTE, 3G, wireless LAN, and Bluetooth (registered trademark) are used. The communication network NW includes, for example, a wide area network (WAN), a local area network (LAN), the Internet, a dedicated line, a wireless base station, a provider, and the like.

The auxiliary storage device 105 includes a readable and writable storage medium and a drive device for reading and writing various types of information such as programs and data from and to the storage medium. In the auxiliary storage device 105, a semiconductor memory such as a hard disk or a flash memory can be used as a storage medium.

The auxiliary storage device 105 has a program storage area that stores a program for the inference processing device 1 to perform inference. Furthermore, the auxiliary storage device 105 may include, for example, a backup area for backing up the above-described data, programs, and the like. The auxiliary storage device 105 can store, for example, an inference processing program.

The input and output I/O 106 includes an I/O terminal that inputs a signal from an external device such as the display device 107 or outputs a signal to the external device.

The inference processing device 1 may be achieved not only by one computer but also distributed by a plurality of computers connected to each other via the communication network NW. The processor 102 may be achieved by hardware such as a field-programmable gate array (FPGA), a large scale integration (LSI), and an application specific integrated circuit (ASIC).

In particular, by configuring the inference operation unit 13 using a rewritable gate array such as FPGA, the circuit configuration can be flexibly rewritten according to the configuration of the input data X and the neural network model to be used. In this case, it is possible to achieve the inference processing device 1 capable of supporting various applications.

### Extension of Embodiments

Although the present invention has been described with reference to the embodiments, the present invention is not limited to the above embodiments. Various changes that can be understood by those skilled in the art can be made in the configuration and details of the present invention within the scope of the present invention. In addition, each embodiment can be implemented in any combination within a range not contradictory.

### REFERENCE SIGNS LIST

1 Inference processing device

10 First storage unit

11 Data filtering unit

12 Second storage unit

13 Inference operation unit 13

14 Third storage unit

101 Bus

102 Processor

103 Main storage device

104 Communication interface

105 Auxiliary storage device

106 Input and output I/O

107 Display device

108 Sensor.

1-7. (canceled)

8. An inference processing device inferring a feature of input data through a learned neural network, the inference processing device comprising:
a first storage circuit configured to store the input data;
a second storage circuit configured to store a weight of the learned neural network;
a data filter configured to extract only specific input data from the input data that have been received; and
an inference operator configured to use the specific input data extracted by the data filter and the weight as inputs, perform inference operation of the learned neural network, and infer the feature of the input data.

9. The inference processing device according to claim 8, wherein the data filter is configured to:
determine similarity between the input data that has been received and input data of a previous inference operation;
extract the input data that has been received as the specific input data when determining that the input data that has been received and the input data of the previous inference operation are not similar to each other; and
not extract the input data that has been input as the specific input data when determining that the input data that has been received and the input data of the previous inference operation are similar to each other.

10. The inference processing device according to claim 9,
wherein the data filter includes a comparator configured to compares a difference of the input data with a preset threshold, and wherein the data filter is configured to determine presence or absence of the similarity based on a comparison result of the comparator.

11. The inference processing device according to claim 8, wherein:
the first storage circuit receives and stores a plurality of pieces of input data from a plurality of different data generation sources; and
the data filter is configured to:
determine similarity between the plurality of pieces of input data;
when determining that there is no similar input data in the plurality of pieces of input data, extract the plurality of pieces of input data as the specific input data to the inference operator; and
when determining that there are pieces of similar data in the plurality of pieces of input data, extract input data that is not similar and any one piece of input data in pieces of input data that are similar, among the plurality of pieces of input data, as the specific input data to the inference operator.

12. The inference processing device according to any claim 8, wherein:
the first storage circuit is configured to receive and store a plurality of pieces of input data from a plurality of different data generation sources; and
the data filter is configured to:
determine both similarity between the plurality of pieces of input data and similarity between the plurality of pieces of input data that have been received and input data of previous inference operation;
when determining that each of the plurality of pieces of input data that have been received is not similar to another piece of input data of the plurality of pieces of input data and the input data of the previous inference operation, extract the plurality of pieces of input data that have been received as the specific input data to the inference operator;
when determining that there are pieces of input data that are similar in the plurality of pieces of input data, extract any one piece of input data from the pieces of input data that are similar; and
when determining that the input data that has been extracted is not similar to the input data of the previous inference operation, extract the input data that has been extracted as the specific input data to the inference operator.

13. The inference processing device according to claim 8, wherein the data filter is configured to use output data of the inference operator as input data to the data filter.

14. The inference processing device according to claim 8, wherein the inference operator is configured to use output data of the inference operator as the input data to the inference operator.

15. An method of operating an inference processing device inferring a feature of input data through a learned neural network, the method comprising:
storing, by the inference processing device, the input data;
storing, by the inference processing device, a weight of the learned neural network;
extracting, by a data filter of the inference processing device, only specific input data from the input data that have been received; and
using, by an inference operator, the specific input data extracted by the data filter and the weight as inputs, perform inference operation of the learned neural network, and infer the feature of the input data.

16. The method according to claim 15, wherein extracting only the specific input data from the input data that have received comprises:
determining similarity between the input data that has been received and input data of a previous inference operation;
extracting the input data that has been received as the specific input data when determining that the input data that has been received and the input data of the previous inference operation are not similar to each other; and
not extracting the input data that has been input as the specific input data when determining that the input data that has been received and the input data of the previous inference operation are similar to each other.

17. The method according to claim 16, wherein determining the similarity between input data that has been received and input data of the previous inference operation comprises comparing a difference of the input data that have been received with a preset threshold.

18. The method according to claim 15, wherein:
storing the input data comprises storing a plurality of pieces of input data from a plurality of different data generation sources; and
extracting only the specific input data from the input data that have received comprises:
determining similarity between the plurality of pieces of input data;
when determining that there is no similar input data in the plurality of pieces of input data, extract the plurality of pieces of input data as the specific input data; and
when determining that there are pieces of similar data in the plurality of pieces of input data, extract input data that is not similar and any one piece of input data in pieces of input data that are similar, among the plurality of pieces of input data, as the specific input data.

19. The method according to claim 15, wherein:
storing the input data comprises storing a plurality of pieces of input data from a plurality of different data generation sources; and
extracting only the specific input data from the input data that have received comprises:
determine both similarity between the plurality of pieces of input data and similarity between the plurality of pieces of input data that have been received and input data of previous inference operation;
when determining that each of the plurality of pieces of input data that have been received is not similar to another piece of input data of the plurality of pieces of input data and the input data of the previous inference operation, extract the plurality of pieces of input data that have been received as the specific input data;
when determining that there are pieces of input data that are similar in the plurality of pieces of input data, extract any one piece of input data from the pieces of input data that are similar; and
when determining that the input data that has been extracted is not similar to the input data of the previous inference operation, extract the input data that has been extracted as the specific input data.

20. The method according to claim 15, further comprising using output data of the inference operator as input data to the data filter.

21. The method according to claim 15, further comprising using output data of the inference operator as the input data to the inference operator.
